(19) United States
(12) Patent Application Publication
(10) Pub. No.: US 2026/0095732 A1
(43) Pub. Date: Apr. 2, 2026

(54) APPARATUSES AND COMMUNICATION METHODS USING UE INFORMATION

(71) Applicant: GUANGDONG OPPO MOBILE TELECOMMUNICATIONS CORP., LTD., Dongguan (CN)

(72) Inventors: Alla GOLDNER, Tel Aviv (IL); Yang XU, Dongguan (CN); Jingran CHEN, Dongguan (CN)

(73) Assignee: GUANGDONG OPPO MOBILE TELECOMMUNICATIONS CORP., LTD., Dongguan (CN)

(21) Appl. No.: 19/402,944

(22) Filed: Nov. 26, 2025

Related U.S. Application Data
(63) Continuation of application No. PCT/CN2023/120618, filed on Sep. 22, 2023.

(51) Int. Cl. H04W 4/50

(52) U.S. Cl. CPC H04W 4/50

(57) ABSTRACT

A communication method using member user equipment (UE) information includes subscribing or unsubscribing, by a first network function (NF), a member UE selection information at a second NF or a third NF, receiving, by the first NF, a notification association with the member UE selection information from the second NF or the third NF, and making, by the first NF, a policy decision based on the notification association with the member UE selection information.

### CROSS-REFERENCE TO RELATED APPLICATIONS

This application is a continuation of International Application No. PCT/CN2023/120618, filed on Sep. 22, 2023, the disclosure of which is hereby incorporated by reference in its entirety.

### TECHNICAL FIELD

The present disclosure relates to the field of communication systems, and more particularly, to apparatuses and communication methods using member user equipment (UE) information such as a member UE list as an input for network function (NF) decisions.

### BACKGROUND

There is currently standardization activity in 3rd generation partnership project (3GPP) work studying member user equipment (UE) selection assistance functionality. However, in current technologies and/or standardizations, aspects for additional network functions awareness are open issues.

Therefore, there is a need for apparatuses and communication methods using member user equipment (UE) information, which can address these issues and other issues.

### SUMMARY

An object of the present disclosure is to propose apparatuses and communication methods using member user equipment (UE) information, which can address these issues and other issues in the prior art.

In a first aspect of the present disclosure, a communication method using member user equipment (UE) information includes subscribing or unsubscribing, by a first network function (NF), a member UE selection information at a second NF or a third NF, receiving, by the first NF, a notification association with the member UE selection information from the second NF or the third NF, and making, by the first NF, a policy decision based on the notification association with the member UE selection information.

In a second aspect of the present disclosure, a communication device includes a subscriber configured to subscribe or unsubscribe a member UE selection information at a network function (NF), a receiver configured to receive a notification association with the member UE selection information from the NF, and an actuator configured to make a policy decision based on the notification association with the member UE selection information.

In a third aspect of the present disclosure, a network device includes a memory, a transceiver, and a processor coupled to the memory and the transceiver. The network device is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of non-roaming 5G system architecture configured to implement some embodiments presented herein.

FIG. 2 is a block diagram of roaming 5G system architecture configured to implement some embodiments presented herein.

FIG. 3 is a block diagram of roaming 5G system architecture configured to implement some embodiments presented herein.

FIG. 4 is a block diagram of a network device according to an embodiment of the present disclosure.

FIG. 5 is a flowchart illustrating a communication method using member user equipment (UE) information according to an embodiment of the present disclosure.

FIG. 6 is a block diagram of a communication device according to an embodiment of the present disclosure.

FIG. 7 is a flowchart illustrating procedure for update of member UE selection information in policy control function (PCF) according to an embodiment of the present disclosure.

FIG. 8 is a flowchart illustrating 5G core network (5GC) assistance to member UE selection and update according to an embodiment of the present disclosure.

FIG. 9 is a flowchart illustrating procedure for update of member UE selection information in PCF according to an embodiment of the present disclosure.

FIG. 10 is a block diagram of an example of a computing device according to an embodiment of the present disclosure.

FIG. 11 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

According to current 3GPP artificial intelligence (AI)/machine learning (ML) standardization, 5G system may support member UE selection assistance functionality to assist an AF to select member UE(s) that can be used in application operations such as AI/ML based applications (e.g. Federated Learning) according to the AF's inputs. The Member UE selection assistance functionality can be hosted by NEF. In some examples, as defined in the 3GPP specifications, AF provides a list of target UE(s) and at least one member UE filtering criterion as part of the service operation parameters to assist the candidate UEs selection. Upon receiving the AF request, NEF triggers corresponding 5GC procedures to retrieve the information for the UE in the list of target UE(s) from 5GC NFs. Before sending the list(s) of candidate UEs to the AF, NEF consolidates all the information collected from other 5GC NFs and derives one or more list(s) of candidate UEs and possibly additional information according to the member UE filtering criteria requested by the AF. Once this list is derived, NEF sends it back to the AF so those member UEs can take part in AI/ML operation e.g., Federated Learning. However, the current standardization doesn't support additional network functions awareness e.g. PCF's awareness of member UE selection. Thus, as PCF is not aware, PCF may make its policy decisions e.g. due to spending limits control, usage monitoring threshold crossing, day/night change of policy which e.g. reduce the quality of service (QoS) of the corresponding UEs/PDU sessions/applications. Eventually, NEF would become aware of such reduction in case QoS is one of member UE filtering criteria through the information received from SMF/UPF or UDM and may exclude the specific UEs from member UE list. However, such exclusion may not be beneficial and could be prevented if e.g., PCF is aware of such UEs becoming a part of member UE selection. This is just one example of the issues which might be resolved once NF e.g., PCF becomes aware of member UE selection. Some embodiments of the present disclosure can address these issues and other issues.

There are several related technologies which are leveraged by some embodiments of the present disclosure:
1. Usage Monitoring:

Usage Monitoring: Usage monitoring control requirements to monitor, both volume and time usage, and report the accumulated usage of network resources apply for PDU Sessions of type IP and Ethernet. It is possible to apply usage monitoring for the accumulated usage of network resources on a per Session and user basis. This capability is required for enforcing dynamic policy decisions based on the total network usage in real-time. The PCF that uses usage monitoring for making dynamic policy decisions may set and send the applicable thresholds to the SMF for monitoring. The usage monitoring thresholds may be based either on time, or on volume. The PCF may send both thresholds to the SMF. The SMF can notify the PCF when a threshold is reached and report the accumulated usage since the last report for usage monitoring. If both time and volume thresholds were provided to the SMF, the accumulated usage since last report can be reported when either the time or the volume thresholds are reached. The usage monitoring capability is possible for an individual or a group of service data flow(s), or for all traffic of a PDU Session in the SMF. When usage monitoring for all traffic of a PDU Session is enabled, it is possible to exclude an individual SDF or a group of service data flow(s) from the usage monitoring for all traffic of this PDU Session. It is possible to activate usage monitoring both to service data flows associated with predefined PCC rules and dynamic PCC rules, including rules with deferred activation and/or deactivation times while those rules are active. If service data flow(s) need to be excluded from PDU Session level usage monitoring and PDU Session level usage monitoring is enabled, the PCF can provide an indication of exclusion from session level monitoring associated with the respective PCC rule(s). It is possible to apply different usage monitoring depending on the access used to carry a service data flow.

Usage Monitoring: The PCF supports usage monitoring control for a PDU Session or per Monitoring Key. Usage is defined as either volume or time of user plane traffic. The PCF may receive usage monitoring related information per DNN and S-NSSAI combination and UE from the UDR, i.e., the overall amount of allowed resources (based either on traffic volume and/or traffic time) that are to be monitored for the PDU Sessions of a user, together with the corresponding remaining allowed usage related information. In addition, usage monitoring related information for Monitoring key(s) per DNN and S-NSSAI combination and UE may also be received from the UDR, together with the corresponding remaining allowed usage related information. For the purpose of usage monitoring per access type, the PCF receives an individual Monitoring key per access type from UDR. Details about the usage monitoring related information and the remaining allowed usage related information provided by the UDR. For the purpose of usage monitoring control, the PCF can request the Usage report trigger and provide the necessary usage threshold(s), either volume threshold, time threshold, or both volume threshold and time threshold, upon which the SMF can report to the PCF. The PCF can decide if and when to activate usage monitoring to the SMF. The PCF may provide a Monitoring time to the SMF for the Monitoring keys(s) and optionally specify a subsequent threshold value for the usage after the Monitoring time. If the SMF reports usage before the Monitoring time is reached, the Monitoring time is not retained by the SMF. Therefore, the PCF may again provide a Monitoring time and optionally the subsequent threshold value for the usage after the Monitoring time in the response. It is possible for the PCF to request a usage report from the SMF. The PCF ensures that the number of requests/following policy decisions provided to the SMF do not cause excessive signaling load by e.g., assigning the same time for the report only for a preconfigured number of PDU Sessions. Once the PCF receives a usage report from the SMF the PCF can hall deduct the value of the usage report from the remaining allowed usage for that DNN and S-NSSAI combination and UE (if usage per PDU Session is reported). If usage is reported from the SMF, the PCF can deduct the value of the usage report from the remaining allowed usage for individual Monitoring key(s) for that DNN and S-NSSAI combination and UE (if usage for one or several Monitoring keys is reported). The PCF maintains usage thresholds for each Monitoring key and PDU Session that is active for a certain DNN and S-NSSAI combination and UE. Updating the remaining allowed usage after the SMF reporting, minimizes the risk of exceeding the usage allowance. If the remaining allowed usage reaches a value of zero (or below zero), the PCF may apply other policy decisions and interact with the SMF accordingly. If the SMF reports usage for a certain Monitoring key and if monitoring can continue for that monitoring key, then the PCF can provide new threshold value(s) in the response to the SMF respectively. If Monitoring time and subsequent threshold value are used, then the PCF provides them to the SMF as well. The PCF may provide a new volume threshold and/or a new time threshold to the SMF, the new threshold values override the existing threshold values in the SMF. If monitoring may no longer continue for that Monitoring key, then the PCF may not provide a new threshold in the response to the SMF. If the last PDU Session of a user for a DNN and S-NSSAI combination is terminated, the PCF can store the remaining allowed usage, i.e., the information about the remaining overall number of resources, in the UDR. If the End date of the usage monitoring related information is reached, the PCF may reset the remaining allowed usage to the value(s) indicated in the usage monitoring related information and may then interact with the SMF to undo any previously applied policy decisions related to remaining allowed usage of zero (or below zero).
2. Spending Limit Control: It is possible to enforce policies based on subscriber spending limits. The CHF may maintain policy counter(s) to track spending for a subscription. These policy counters may be available in the CHF prior to their use over the N28 interface. The PCF can request information regarding the subscriber's spending from the CHF, to be used as input for dynamic policy decisions for the subscriber, using subscriptions to spending limit reports. The CHF can make information regarding the subscriber's spending available to the PCF using spending limit reports.
3. Member UE selection assistance.

Some embodiments of the present disclosure may leverage member UE awareness by network function e.g., PCF in order to make more sophisticated policy decisions so e.g., the QoS of the corresponding UEs is not reduced, the charging key (i.e., rating) might change to benefit the UEs participating in the operation, Spending Limit Control and/or usage monitoring thresholds are changed and/or not enforced. This helps to keep the most appropriate members of member UE selection list not affected by policy downgrade decisions, and in some cases even benefited for participating in the AI/ML operation e.g., in the Federated Learning operation.

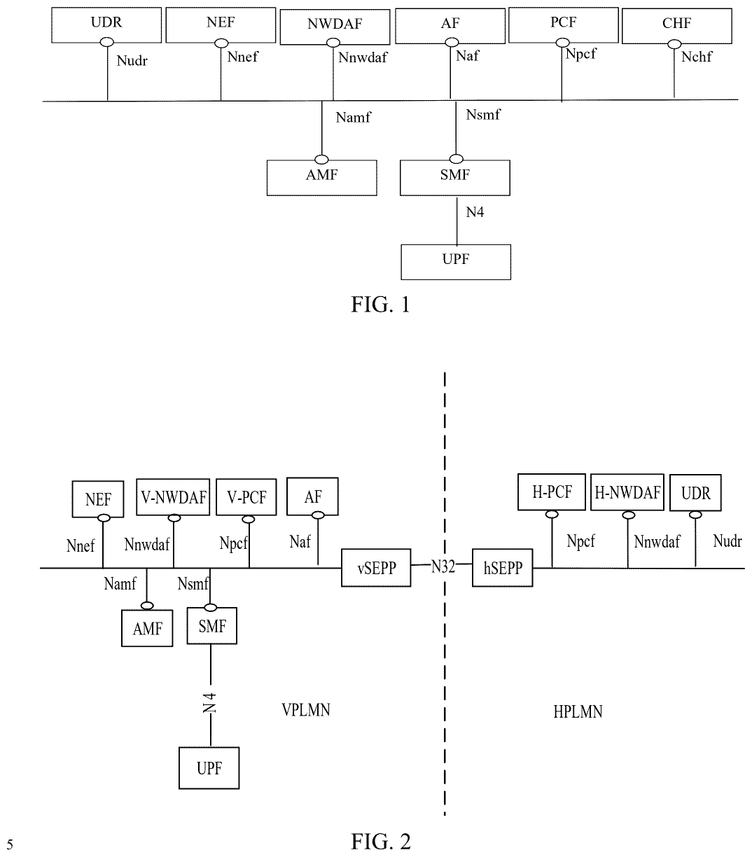

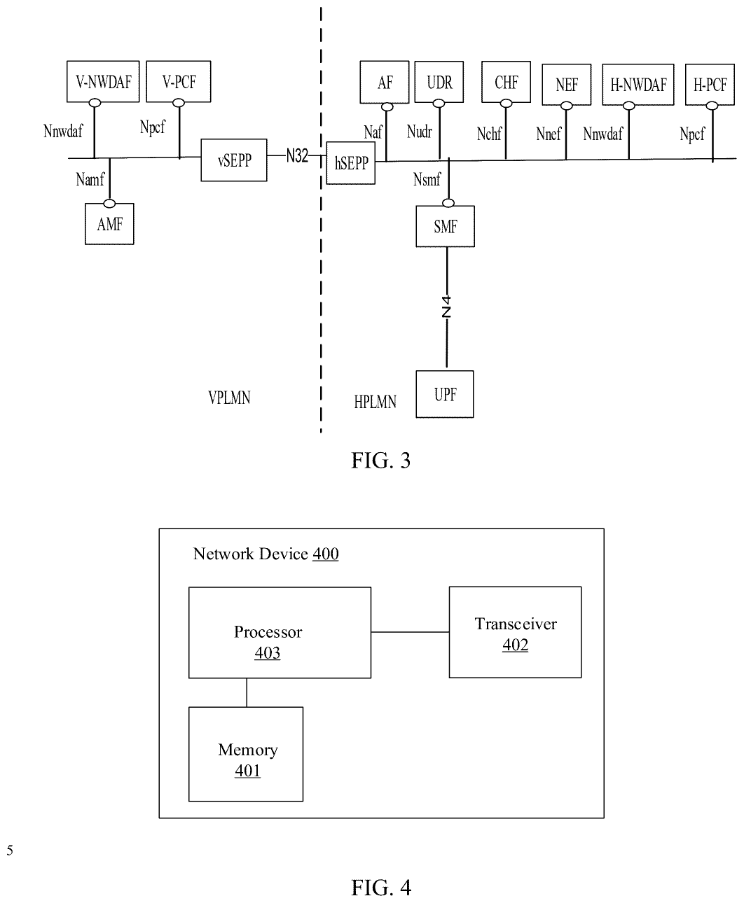

FIG. 1 illustrates a non-roaming 5G system architecture configured to implement some embodiments presented herein. FIG. 2 illustrates a roaming 5G system architecture configured to implement some embodiments presented herein. FIG. 3 illustrates a roaming 5G system architecture configured to implement some embodiments presented herein. In these system architectures as illustrated in FIG. 1 to FIG. 3, network functions communicate with each other over a service-based interface. The 5G system architecture includes the following network functions (NF): user plane function (UPF), access and mobility management function (AMF), session management function (SMF), unified data repository (UDR), network exposure function (NEF), network data analytics function (NWDAF), application function (AF), policy control function (PCF), and charging Function (CHF), etc.

The following descriptions highlight some of the capabilities of the network functions (NFs) from FIG. 1 that are involved with control signaling.

Access and Mobility Function (AMF): The UE sends an NI message through the RAN node to the AMF to perform control plane signaling such as registration, connection management, mobility management, access authentication and authorization, etc.

Session Management Function (SMF): The SMF is responsible for session management involved with establishing PDU sessions to allow UEs to send data to Data Networks (DNs) such as the internet or to an application server and other session management related functions.

Policy and Control Function (PCF): The PCF provides the policy framework that governs network behavior, accesses subscription information to make policy decisions, etc.

Network Exposure Function (NEF): The NEF supports the exposure of capabilities and events in the core network to third parties, Application Functions (AF), Edge Computing, etc.

The PCF/NEF stores/retrieves information related with policy subscription data or with application data. Further, the PCF in visited public land mobile network (VPLMN) may interact with the AF in order to generate policy and charging control (PCC) rules for services delivered via the VPLMN. The PCC rule may refer to a set of information enabling the detection of a service data flow and providing parameters for policy control and/or charging control and/or other control or support information. The PCF in the VPLMN uses locally configured policies according to the roaming agreement with the HPLMN operator as input for PCC Rule generation. The PCF in VPLMN has no access to subscriber policy information from the HPLMN for PCC Rule generation. The PCF in the VPLMN can provide access and motility policy information without contacting the PCF in the HPLMN. AF requests providing routing information for roamers targeting a DNN and S-NSSAI (targeting all roamers) or an External-Group-Identifier (identifying a group of roamers) are stored as Application Data in the UDR (in the VPLMN) by the NEF (in the VPLMN). AF requests influencing AM policy for roamers targeting any inbound roaming UEs together with combination(s) of DNN and S-NSSAI or External Application Identifier(s) are stored as Application Data in the UDR (in the VPLMN) by the NEF (in the VPLMN). The inbound roamers are identified by their home public land mobile network (PLMN) ID(s).

FIG. 4 illustrates an example of a network device 400 according to an embodiment of the present disclosure. The network device 400 is configured to implement some embodiments of the disclosure. Some embodiments of the disclosure may be implemented into the network device 400 using any suitably configured hardware and/or software. The network device 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 403 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the memory 401 stores executable instructions that when executed by the processor cause the processor 403 to effectuate operations including: subscribing or unsubscribing, by a first network function (NF), a member UE selection information at a second NF or a third NF; receiving, by the first NF, a notification association with the member UE selection information from the second NF or the third NF; and making, by the first NF, a policy decision based on the notification association with the member UE selection information.

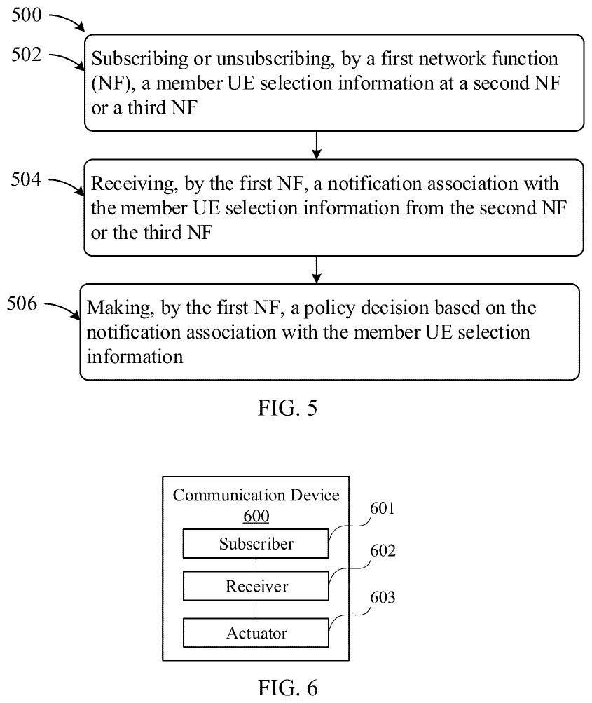

FIG. 5 illustrates a communication method using member user equipment (UE) information according to an embodiment of the present disclosure. FIG. 5 is an example of a communication method 500 using member user equipment (UE) information according to an embodiment of the present disclosure. The communication method 500 using member user equipment (UE) information is configured to implement some embodiments of the disclosure. Some embodiments of the disclosure may be implemented into the communication method 500 using member user equipment (UE) information using any suitably configured hardware and/or software. In some embodiments, the communication method 500 using member user equipment (UE) information includes: an operation 502, subscribing or unsubscribing, by a first network function (NF), a member UE selection information at a second NF or a third NF, an operation 504, receiving, by the first NF, a notification association with the member UE selection information from the second NF or the third NF, and an operation 506, making, by the first NF, a policy decision based on the notification association with the member UE selection information.

In some embodiments, the first NF is a policy control function (PCF), the second NF is a network exposure function (NEF), and the third NF is an application function (AF). In some embodiments, the method further includes selecting and/or updating the member UE selection information. In some embodiments, selecting and/or updating the member UE selection information includes performing, by the first NF, a subscription to notification from the second NF or the third NF to the member UE selection information by sending a subscription request. In some embodiments, selecting and/or updating the member UE selection information further includes detecting, by the second NF or the third NF, that the member UE selection information has been changed. In some embodiments, selecting and/or updating the member UE selection information further includes if subscribed by the first NF, the second NF or the third NF notifies the first NF on a changed member UE selection information.

In some embodiments, selecting and/or updating the member UE selection information further includes storing, by the first NF, an updated member UE selection information. In some embodiments, selecting and/or updating the member UE selection information further includes if the updated member UE selection information requires a status of a policy counters available at a charging function (CHF), an initial/intermediate spending limit report retrieval is initiated by the first NF; if the updated member UE selection information implies that no policy counter status is needed, the initial/intermediate spending limit report retrieval is initiated by the first NE to unsubscribe; or if the updated member UE selection information is a last policy counter status, a final spending limit report retrieval is initiated by the first NF.

In some embodiments, selecting and/or updating the member UE selection information further includes making, by the first NF, an authorization and policy decision. In some embodiments, selecting and/or updating the member UE selection information further includes providing, by the first NF, session management related policy decisions to a session management function (SMF), using a policy related interaction in a protocol data unit (PDU) session modification procedure, an access and mobility related policy information to an access and mobility function (AMF) using an access and mobility (AM) policy association modification procedure, or a UE policy information to the AMF using a UE policy association modification procedure.

In some embodiments, selecting and/or updating the member UE selection information includes at least one of the followings: subscribing, by the third NF, to a member UE selection assistance by sending a subscription request including a list of target UEs, one or more UE member filtering criteria, and/or one or more time windows; updating, by the third NF, the one or more UE member filtering criteria; providing, by the third NF, a subscription correlation identifier (ID). In some embodiments, selecting and/or updating the member UE selection information further includes subscribing, by the first NF, to the member UE selection information by sending a first subscription request. In some embodiments, selecting and/or updating the member UE selection information further includes at least one of the followings: verifying, by the second NF, an authorization of a third NF request, identifying, by the second NF, information which needs to be collected for each UE in a list of target UEs, executing, by the second NF, a service operation based on a member UE filtering criteria provided by the third NF; correlating, by the second NF, a second subscription request to an existing subscription according to a subscription correlation ID.

In some embodiments, selecting and/or updating the member UE selection information further includes interacting, by the second NF, with NFs to collect information for each UE in the list of target UEs. In some embodiments, selecting and/or updating the member UE selection information further includes based on a collected information from the NFs, consolidating, by the second NF, all the information collected from the NFs to derive one or more lists of candidate UEs which fulfil the member UE filtering criteria in the third NF request. In some embodiments, selecting and/or updating the member UE selection information further includes sending, by the second NF, a notification request to the third NF and/or to the first NF if the first NF has previously subscribed to the member UE selection information, by including the one or more lists of candidate UEs and/or additional information.

FIG. 6 illustrates a communication device according to an embodiment of the present disclosure. FIG. 6 illustrates that, in some embodiments, a communication device 600 includes a subscriber 601 configured to subscribe or unsubscribe a member UE selection information at a network function (NF), a receiver 602 configured to receive a notification association with the member UE selection information from the NF, and an actuator 603 configured to make a policy decision based on the notification association with the member UE selection information.

In some embodiments, the communication device 600 further includes a policy control function (PCF) and the NF. The subscriber 601, the receiver 602, and the actuator 603 are components of the PCF, and the NF is a network exposure function (NEF) or an application function (AF). In some embodiments, the actuator 603 is further configured to select and/or update the member UE selection information. In some embodiments, the actuator 603 is further configured to perform a subscription to notification from the NF to the member UE selection information by sending a subscription request. In some embodiments, the NF is further configured to detect that the member UE selection information has been changed. In some embodiments, if subscribed by the subscriber 601, the NF notifies the subscriber on a changed member UE selection information.

In some embodiments, the actuator 603 is further configured to store an updated member UE selection information. In some embodiments, if the updated member UE selection information requires a status of a policy counters available at a charging function (CHF), an initial/intermediate spending limit report retrieval is initiated by the subscriber 601; if the updated member UE selection information implies that no policy counter status is needed, the initial/intermediate spending limit report retrieval is initiated by the subscriber 601 to unsubscribe; or if the updated member UE selection information is a last policy counter status, a final spending limit report retrieval is initiated by the subscriber 601. In some embodiments, the actuator 603 is further configured to make an authorization and policy decision. In some embodiments, the actuator 603 is further configured to provide session management related policy decisions to a session management function (SMF), using a policy related interaction in a protocol data unit (PDU) session modification procedure, an access and mobility related policy information to an access and mobility function (AMF) using an access and mobility (AM) policy association modification procedure, or a UE policy information to the AMF using a UE policy association modification procedure.

In some embodiments, the AF is configured to subscribe to a member UE selection assistance by sending a subscription request including a list of target UEs, one or more UE member filtering criteria, and/or one or more time windows; wherein the AF is configured to update the one or more UE member filtering criteria; the AF is configured to provide a subscription correlation identifier (ID). In some embodiments, the subscriber 601 is further configured to subscribe to the member UE selection information by sending a first subscription request. In some embodiments, the NEF is configured to verify an authorization of an AF request, identify information which needs to be collected for each UE in a list of target UEs, and execute a service operation based on a member UE filtering criteria provided by the AF; and/or the NEF is configured to correlate a second subscription request to an existing subscription according to a subscription correlation ID. In some embodiments, the NEF is configured to interact with NFs to collect information for each UE in the list of target UEs. In some embodiments, based on a collected information from the NFs, the NEF is configured to consolidate all the information collected from the NFs to derive one or more lists of candidate UEs which fulfil the member UE filtering criteria in the AF request. In some embodiments, the NEF is configured to send a notification request to the AF and/or to the subscriber if the subscriber has previously subscribed to the member UE selection information, by including the one or more lists of candidate UEs and/or additional information.

### EXAMPLES

According to current 3GPP AI/ML standardization, 5G system may support member UE selection assistance functionality to assist the AF to select member UE(s) that can be used in application operations such as AI/ML based applications (e.g., Federated Learning) according to the AF's inputs. The member UE selection assistance functionality can be hosted by NEF. As defined by 3GPP specifications, AF provides a list of target UE(s) and at least one member UE filtering criterion as part of the service operation parameters to assist the candidate UEs selection. Upon receiving the AF request, NEF triggers corresponding 5GC procedures to retrieve the information for the UE in the list of target UE(s) from 5GC NFs. Before sending the list(s) of candidate UEs to the AF, NEF consolidates all the information collected from other 5GC NFs and derives one or more list(s) of candidate UEs and possibly additional information according to the Member UE filtering criteria requested by the AF. Some member UE filtering criteria and the corresponding procedures may be defined in 3GPP specifications.

It is therefore proposed to additionally define the following enhancements: The following solution selection can be based on pre-provisioning and/or operator's policy and/or NEF capabilities/suggestion and/or AF capabilities/suggestion.

### Alternative Solution 1: NEF Provides Member UE Information.

The final decision to decide on member UE list can be made by AF upon getting the information from NEF. It is assumed in this solution that AF may fully adopt NEF's suggestion.
1. NF e.g., PCF subscribes/unsubscribes for Member UE list at NEF.
2. Once Member UE list is determined by NEF after interactions with NFs etc. as defined by the existing specifications, NEF sends it to AF and, in case e.g., PCF has subscribed to it, also to e.g. PCF by leveraging Notify message.
3. NF e.g., PCF, by leveraging Operator's policy and its own internal algorithms, may now take this information into consideration as an input for its policy decisions when e.g., applying Spending Limit Control and/or usage monitoring threshold crossing enforcement, and or updating charging key (i.e., rating) and/or any related policy enforcement which e.g., may affect/downgrade QoS of the corresponding application/PDU session/UE etc.

It is understood that the rationale behind e.g., PCF's action is to preserve Member UE selected list as decided by NEF (as any QoS downgrade decision may eventually cause exclusion of the specific UE(s) from the Member UE list e.g., if QoS is defined as one of Member UE Filtering criteria). Furthermore, UEs which are selected within member UE selection, may get some benefits e.g. improving their rating conditions, not downgrading their QoS for significant period of time even though they may come close to their predefined spending limits etc.

Specific points of some embodiments which would affect standards:

### Interactions Between NEF and PCF

Npcf and Nnef enable the negotiation of policy and charging control behavior between PCF and NEF by supporting the following functionality:
service specific policy and charging control;
sponsor data connectivity including usage monitoring;
Application Function influence on traffic routing;
Application Function influence on Service Function Chaining;
subscription and reporting of events for the event exposure;
negotiations for future background data transfer;
negotiation of planned data transfer with QoS requirements;
member UE selection information.

The N30 reference point is defined for the interactions between PCF and NEF in the reference point representation.

Some embodiments newly define service between NEF and PCF to notify PCF in case of Member UE information changes.

Nnef_MemberUESelectionInformation service

### General

The service provides the capability to subscribe, unsubscribe or notify the Member UE selection information from the NEF.

Nnef_MemberUESelectionInformation_Subscribe service operation

Service operation name: Nnef_MemberUESelectionInformation_Subscribe

Description: The NF consumer subscribes to receive the Member UE selection information.

Inputs, Required: None.

Inputs, Conditional Required: None.

Inputs, Optional: None.

Outputs, Required: When the subscription is accepted: Subscription Correlation ID, Expiry time (required if the subscription can be expired based on the operator's policy).

Nnef_MemberUESelectionInformation_Unsubscribe service operation

Service operation name: Nnef_MemberUESelectionInformation_Unsubscribe

Description: The NF consumer deletes a subscription for Member UE selection information that is already created in NEF.

Inputs, Required: Subscription Correlation ID.

Outputs, Required: Operation execution result indication.

Nnef_MemberUESelectionInformation_Notify service operation

Service operation name: Nnef_MemberUESelectionInformation_Notify

Description: NEF reports the Member UE selection information to the consumer that has previously subscribed.

Inputs, Required: Notification Correlation Information.

Inputs, Conditional Required:

At least one of the following inputs is required:
One or more list(s) of candidate UE(s).

Inputs, Optional: Recommended time window for performing the application operation per list of candidate UE(s) as described in clause 4.15.13.1, specific value of the parameters that NEF gathered for the Member UE filtering criteria per candidate UE.

Inputs, Optional: None.

Outputs, Required: Operation execution result indication.

Some embodiments provide new procedure, once e.g. PCF gets notified by NEF about Member UE information changes, e.g. PCF can make an appropriate policy decisions.

Update of the Member UE selection information in the PCF

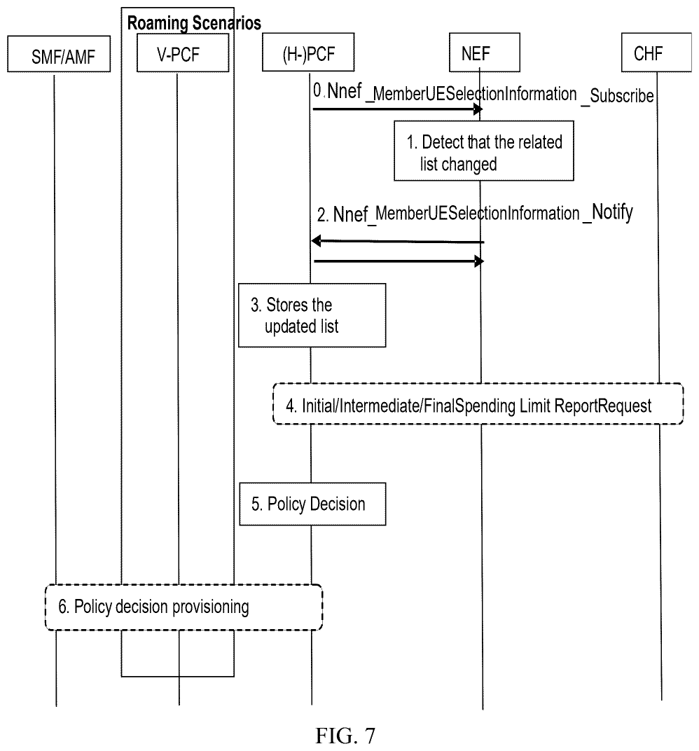

FIG. 7 illustrates procedure for update of member UE selection information in policy control function (PCF) according to an embodiment of the present disclosure. FIG. 7 illustrates at least one of operations as follows:
0. The PCF performs the subscription to notification from the NEF to the Member UE selection information functionality by sending Nnef_MemberUESelectionInformation_subscribe request.
1. The NEF detects that the related Member UE list has been changed.
2. If subscribed by the PCF, the NEF notifies the PCF on the changed list by invoking Nnef_MemberUESelectionInformation_Notify, including the list of Member UEs.
3. The PCF stores the updated list.
4. If the updated list requires the status of new policy counters available at the CHF then an Initial/Intermediate Spending Limit Report Retrieval is initiated by the PCF. If the updated subscriber profile implies that no policy counter status is needed, an Intermediate Spending Limit Report Request Retrieval is initiated by the PCF to unsubscribe or, if this is the last policy counter status, a Final Spending Limit Report Retrieval is initiated by the PCF.
5. PCF makes an authorization and policy decision.
6. The PCF provides new session management related policy decisions to the SMF, using the Policy related interaction in PDU Session Modification procedure, new access and mobility related policy information to the AMF using the AM Policy Association Modification procedure or new UE policy information to the AMF using the UE Policy Association Modification procedure.

Some embodiments regarding Modification to Member UE selection general information flow, so e.g. PCF, if subscribed, gets the information

### Member UE Selection General Information Flow

Some embodiments describe the procedures that are generally applicable independently of the Member UE filtering criteria sent by the AF.

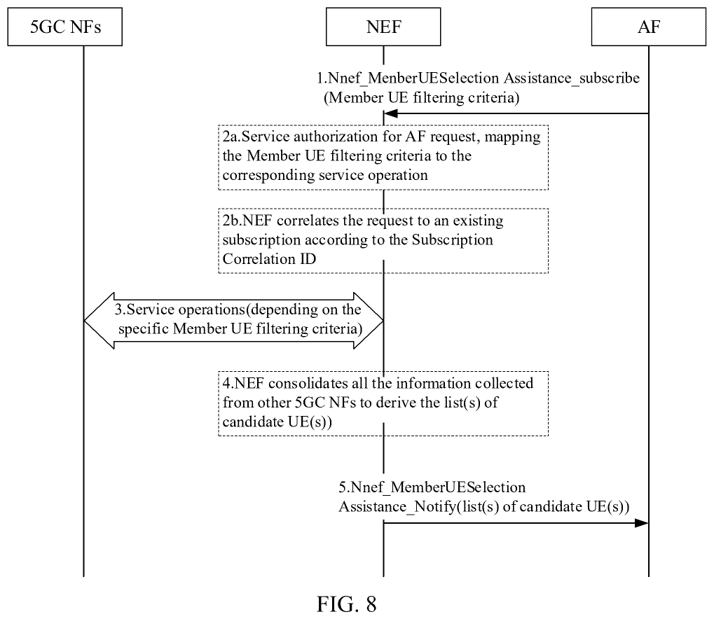

FIG. 8 illustrates 5G core network (5GC) assistance to member UE selection and update according to an embodiment of the present disclosure. FIG. 8 illustrates at least one of operations as follows:
1. AF subscribes to the Member UE selection assistance functionality by sending Nnef_MemberUESelectionAssistance_subscribe request including a list of target UE(s), one or more UE member filtering criteria and optionally, time window(s). Subsequently, the AF may update the filtering criteria of the subscription by invoking Nnef_UEMemberSelectionAssistance_subscribe and providing a Subscription Correlation ID.
1a. PCF may also subscribe to the Member UE selection information functionality by sending Nnef_MemberUESelectionInformation_subscribe request.
2a. [OPTIONAL] NEF verifies the authorization of the AF Request and identifies which information needs to be collected for each UE in the list of target UE(s) and executes the corresponding service operation based on the Member UE filtering criteria provided by the AF, e.g. events, analytics and/or notifications.
2b. [OPTIONAL] The NEF correlates the Nnef_MemberUESelectionAssistance_Subscribe request to an existing subscription according to the Subscription Correlation ID. The NEF uses the target UEs received in step 1 for the Member UE update using the updated filtering criteria.
3. NEF interacts with different 5GC network functions to collect the required information for each UE in the list of target UE(s). The set of interactions between NEF and among 5GC NFs are dependent on the Member UE filtering criteria provided by the AF.
4. Based on the collected information from other 5GC NFs, NEF consolidates all the information collected from other 5GC NFs to derive the list(s) of candidate UE(s) which fulfil the Member UE filtering criteria in the AF request. The NEF may derive recommended time window(s) considering the validity period(s) of the analytics used for Member UE selection criteria, which are a subset of the time window(s) received from the AF.
5. NEF sends a Nnef_MemberUESelectionAssistance_Notify request to the AF and, optionally, to PCF, if PCF has previously subscribed to the Member UE selection information, by including the list(s) of candidate UE(s) and possibly additional information.

NOTE: PCF and its communication with NEF are not shown on the diagram.

### Alternative Solution 2: AF Provides Member UE Information.

In this solution, AF informs about selected UEs (Member UE selection information), once it finally decides, upon getting assistance information from NEF.
1. NF e.g., PCF subscribes/unsubscribes for Member UE list at AF.
2. Once finalized Member UE list is determined by AF, in case e.g., PCF has subscribed to it, it sends it to e.g., PCF by leveraging Notify message
3. NF e.g., PCF, by leveraging Operator's policy and its own internal algorithms, may now take this information into consideration as an input for its policy decisions when e.g. applying Spending Limit Control and/or usage monitoring threshold crossing enforcement, and or updating charging key (i.e., rating) and/or any related policy enforcement which e.g. may affect/downgrade QoS of the corresponding application/PDU session/UE etc.

Specific points in some embodiments which would affect standards:

### Interactions Between PCF and AF

Npcf and Naf enable transport of application level session information and Ethernet/IP port management information from AF to PCF. Such information includes, but is not limited to:
IP filter information or Ethernet packet filter information to identify the service data flow for policy control and/or differentiated charging;
media/application bandwidth requirements for QoS control;
In addition, for sponsored data connectivity:
the sponsor's identification;
optionally, a usage threshold and whether the PCF reports these events to the AF;
information identifying the application service provider and application (e.g. SDFs, application identifier, etc.);
information required to enable Application Function influence on traffic routing;
information required to enable Application Function influence on Service Function Chaining;
information required to enable setting up an AF session with required QoS;
information required to enable setting up an AF session with support for Time Sensitive Networking (TSN).
information required to enable setting up an AF session with support for Time Sensitive Communication.
information required to enable setting up an AF session with support for Deterministic Networking (DetNet).
information about Member UE selection.

Npcf also enables the AF to request to influence Access and Mobility related policies for a UE and enables the AF to provide guidance for UE URSP rule determination. Npcf and Naf enable the AF subscription to notifications on PDU Session events, i.e. the events requested by the AF and the change of DNAI.

The N5 reference point is defined for the interactions between PCF and AF in the reference point representation.

### AF Services

### General

The following table illustrates the AF Services.

TABLE 1
Services provided by AF

| | Service | Operation | Example |
|---|---|---|---|
| Service Name | Operations | Semantics | Consumer(s) |
| Naf_EventExposure | Subscribe | Subscribe/ | NEF, |
| | | Notify | NWDAF, |
| | | | PCF |
| | Unsubscribe | | NEF, |
| | | | NWDAF, |
| | | | PCF |
| | Notify | | NEF, |
| | | | NWDAF, |
| | | | PCF |

### Naf_EventExposure Service

### General

Service description: This service enables consumer NF to subscribe and get notified of events.

The events can be subscribed by a NF consumer.

The following service operations are defined for the Naf_EventExposure service:
Naf_EventExposure_Subscribe.
Naf_EventExposure_Unsubscribe.
Naf_EventExposure_Notify.

The following events can be subscribed by a NF consumer (Event ID):
Service Experience information.
Performance Data information.
Collective Behaviour information.
UE Mobility information.
UE Communication information.
Exceptions information.
User Data Congestion information.
UE Data volume Dispersion information.
DN Performance information.
E2E data volume transfer time information.
Member UE information.

Event Filters are used to specify the conditions to match for notifying the event (i.e. “List of Parameter values to match”). If there are no conditions to match for a specific Event ID, then the Event Filter is not provided. The following table provides some examples on how the conditions to match for event reporting can be specified for various Event IDs for AF exposure.

TABLE 2
Example of Event Filters for AF exposure events

| Event ID for | |
|---|---|
| AF exposure | Event Filter (List of Parameter Values to Match) |
| Exceptions | <Parameter Type = Exception ID, Value = Exception ID1> |
| information | |
| Service | <Parameter Type = TAI, Value = TAI1> |
| Experience | |
| information | |
| Service | <Parameter Type = geographical area, Value = civic |
| Experience | address1 or shape1> |
| information | |
| Collective | <Parameter Type = collective attribute, Value = collective |
| Behavior | value1> |
| information | |
| Collective | <Parameter Type = data processing type, Value = data |
| Behavior | processing type1> |
| information | |

### Naf_EventExposure_Subscribe Service Operation

Service operation name: Naf_EventExposure_Subscribe

Description: The consumer NF subscribes the event to collect AF data for UE(s), group of UEs, list of UEs or any UE, or updates the subscription which is already defined in AF.

Input, Required: Target of Event Reporting (either UE ID(s), or UE IPv4 address(es), or UE IPv6 prefix(es), or Internal/External Group Identifier, or indication that any UE is targeted), (set of) Event ID(s), Notification Target Address (+Notification Correlation ID) and Event Reporting Information.
NOTE 1: UE ID includes GPSI or SUPI.

Input, Optional: NF ID, Event Filter(s) associated with each Event ID, (set of) External Application Identifier(s), Subscription Correlation ID (in the case of modification of the existing subscription), Expiry time.
NOTE 2: In the case of untrusted AF, NEF ID is used as NF ID.

Output, Required: Operation execution result indication. When the subscription is accepted: Subscription Correlation ID, Expiry time (required if the subscription can be expired based on the local policy).

Output, Optional: First corresponding event report is included, if corresponding information is available.

Naf_EventExposure_Unsubscribe service operation.

Service operation name: Naf_EventExposure_Unsubscribe.

Description: The consumer NF unsubscribes for a specific event.

Input, Required: Subscription Correlation ID.

Input, Optional: None.

Output, Required: Operation execution result indication.

Output, Optional: None.

Naf_EventExposure_Notify service operation.

Service operation name: Naf_EventExposure_Notify.

Description: The AF provides the previously subscribed event information to the consumer NF which has subscribed to that event before.

Input, Required: Notification Correlation Information, Event ID, corresponding UE ID(s) (either external UE ID(s), or Internal/External Group Identifier, or UE IP v4 address(es) or UE IP v6 prefix(es), time stamp.

NOTE: UE ID includes GPSI or SUPI.

Input, Optional: Event specific parameter list.

Output, Required: None.

Output, Optional: None.

Some embodiments regarding new procedure, once e.g. PCF gets notified by AF about Member UE information changes, e.g. PCF can make an appropriate policy decisions.

### Update of the Member UE Selection Information in the PCF

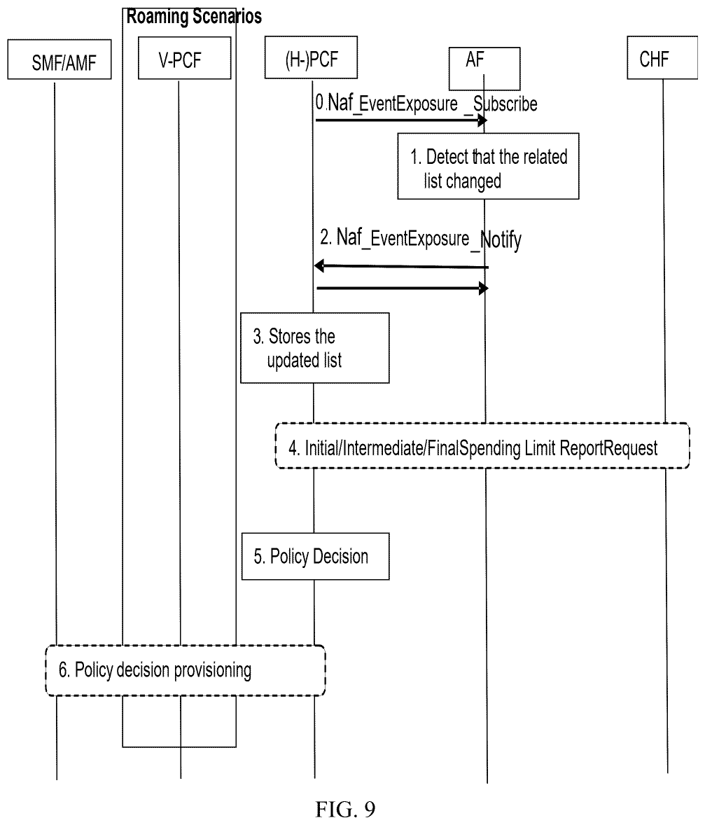

FIG. 9 illustrates procedure for update of member UE selection information in PCF according to an embodiment of the present disclosure. FIG. 9 illustrates at least one of operations as follows:
0. The PCF performs the subscription to notification from the AF to the Member UE selection information functionality by sending Naf_EventExposure_Subscribe request with Event ID equal to “Member UE information.”
1. The AF decides that the related Member UE list has been changed.
2. If subscribed by the PCF, the AF notifies the PCF on the changed list by invoking Naf_EventExposure_Notify, including the list of Member UEs.
3. The PCF stores the updated list.
4. If the updated list requires the status of new policy counters available at the CHF then an Initial/Intermediate Spending Limit Report Retrieval is initiated by the PCF. If the updated subscriber profile implies that no policy counter status is needed, an Intermediate Spending Limit Report Request Retrieval is initiated by the PCF to unsubscribe or, if this is the last policy counter status, a Final Spending Limit Report Retrieval is initiated by the PCF.
5. PCF makes an authorization and policy decision.
6. The PCF provides new session management related policy decisions to the SMF, using the Policy related interaction in PDU Session Modification procedure, new access and mobility related policy information to the AMF using the AM Policy Association Modification procedure or new UE policy information to the AMF using the UE Policy Association Modification procedure.

In summary, some embodiments of the present disclosure disclose awareness of Member UE selection by any Network Function in the 5GC or in 6G. By leveraging this awareness, Network Functions can make more sophisticated decisions about a different UEs functionalities. In 5G, specifically, PCF is highlighted as a Network Function which can benefit from such awareness, by applying the following operations: 1. Subscription/unsubscription by PCF for the Member UE Selection information at NEF or at AF. 2. Once Member UE selection decision is made, transfer of the Member UE list along with the additional available information to the e.g. PCF (notification message from NEF/AF to PCF or to any additional NF). 3. Upon getting such information, e.g. PCF becomes capable of making appropriate policy decisions as described by the corresponding flows.

Commercial interests for some embodiments are as follows. 1. Solve issues in the prior art and other issues. 2. Improving Federated Learning operation in selecting the most appropriate UEs (i.e. Member UE selection assistance). 3. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, a network device, and/or a communication system. Compatible products follow at least one proposed solution, method, system, and apparatus of some embodiments of the present disclosure. The proposed solution, method, system, and apparatus are widely used in a UE, a base station, a network device, and/or a communication system. With the implementation of the at least one proposed solution, method, system, and apparatus of some embodiments of the present disclosure, at least one modification/improvment to methods and apparatus of charging reporting for AI/ML operation are considered for standardizing.

Further, the commercial interest behind some embodiments of this innovation may be in the ability to improve Federated Learning operation in selecting the most appropriate UEs (i.e. Member UE selection assistance). As some embodiments of this invention may cause any Network Function (e.g. PCF) to become aware of Member UE selection i.e. of the UEs selected for e.g. participating in AI/ML operation e.g. in the Federated Learning operation, e.g. PCF may make a more sophisticated policy decisions, based on the operator's policy, so the “best” mostly appropriate list of UEs participate in the operation. The same can apply to the decisions executed by any additional Network Function. Furthermore, those UEs/specific applications run by those UEs, might get benefits for participating in the AI/ML operation e.g. by changing their charging key (rating), not reducing their QoS due to changed Service Plan, changing Spending Limit control, usage monitoring thresholds etc. by e.g. the PCF. Some embodiments of this innovation are not an “end product”, are rather a technique which helps to create an end product with the more advanced Member UE Selection process i.e. more advanced for AI/ML operation e.g. for Federated Learning operation.

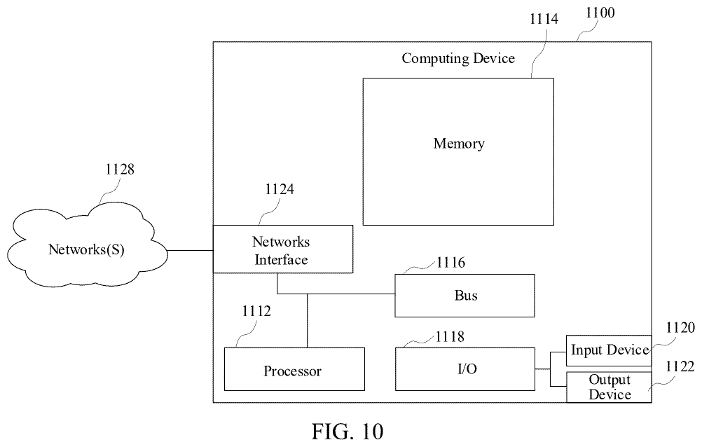

FIG. 10 is an example of a computing device 1100 according to an embodiment of the present disclosure. Any suitable computing device can be used for performing the operations described herein. For example, FIG. 10 illustrates an example of the computing device 1100 that can implement apparautes and/or methods illustrated in FIG. 1 to FIG. 9 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments illustrated in FIG. 1 to FIG. 9. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

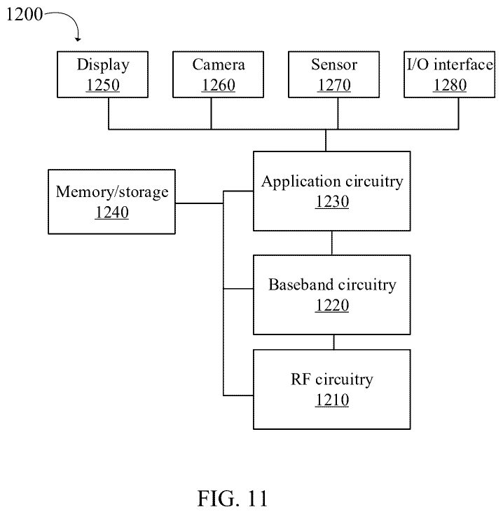

FIG. 11 is a block diagram of an example of a communication system 1200 according to an embodiment of the present disclosure. Embodiments described herein may be implemented into the communication system 1200 using any suitably configured hardware and/or software. FIG. 11 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to FIG. 1 to FIG. 9. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and/or methods illustrated in FIG. 1 to FIG. 9 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an Ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A communication method using member user equipment (UE) information, comprising:
subscribing or unsubscribing, by a first network function (NF), a member UE selection information at a second NF or a third NF;
receiving, by the first NF, a notification association with the member UE selection information from the second NF or the third NF; and
making, by the first NF, a policy decision based on the notification association with the member UE selection information.

2. The method of claim 1, further comprising, selecting and/or updating the member UE selection information;
wherein selecting and/or updating the member UE selection information comprises:
performing, by the first NF, a subscription to notification from the second NF or the third NF to the member UE selection information by sending a subscription request;
and/or wherein selecting and/or updating the member UE selection information further comprises:
detecting, by the second NF or the third NF, that the member UE selection information has been changed;
and/or wherein selecting and/or updating the member UE selection information further comprises:
if subscribed by the first NF, the second NF or the third NF notifies the first NF on a changed member UE selection information;
and/or
wherein selecting and/or updating the member UE selection information further comprises:
storing, by the first NF, an updated member UE selection information.

3. The method of claim 2, wherein selecting and/or updating the member UE selection information comprises at least one of the followings:
subscribing, by the third NF, to a member UE selection assistance by sending a subscription request including a list of target UEs, one or more UE member filtering criteria, and/or one or more time windows; updating, by the third NF, the one or more UE member filtering criteria;
providing, by the third NF, a subscription correlation identifier (ID).

4. The method of claim 3, wherein selecting and/or updating the member UE selection information further comprises:
subscribing, by the first NF, to the member UE selection information by sending a first subscription request.

5. The method of claim 4, wherein selecting and/or updating the member UE selection information further comprises at least one of the followings:
verifying, by the second NF, an authorization of a third NF request, identifying, by the second NF, information which needs to be collected for each UE in a list of target UEs, executing, by the second NF, a service operation based on a member UE filtering criteria provided by the third NF;
correlating, by the second NF, a second subscription request to an existing subscription according to a subscription correlation ID.

6. The method of claim 3, wherein selecting and/or updating the member UE selection information further comprises:
interacting, by the second NF, with NFs to collect information for each UE in the list of target UEs.

7. The method of claim 6, wherein selecting and/or updating the member UE selection information further comprises:
based on a collected information from the NFs, consolidating, by the second NF, all the information collected from the NFs to derive one or more lists of candidate UEs which fulfil the member UE filtering criteria in the third NF request.

8. The method of claim 7, wherein selecting and/or updating the member UE selection information further comprises:
sending, by the second NF, a notification request to the third NF and/or to the first NF if the first NF has previously subscribed to the member UE selection information, by including the one or more lists of candidate UEs and/or additional information.

9. A communication device, comprising:
a subscriber configured to subscribe or unsubscribe a member UE selection information at a network function (NF);
a receiver configured to receive a notification association with the member UE selection information from the NF; and
an actuator configured to make a policy decision based on the notification association with the member UE selection information.

10. The communication device of claim 9, wherein the actuator is further configured to select and/or update the member UE selection information.

11. The communication device of claim 10, wherein the actuator is further configured to perform a subscription to notification from the NF to the member UE selection information by sending a subscription request.

12. The communication device of claim 11, wherein the NF is further configured to detect that the member UE selection information has been changed.

13. The communication device of claim 12, wherein if subscribed by the subscriber, the NF notifies the subscriber on a changed member UE selection information.

14. The communication device of claim 13, wherein the actuator is further configured to store an updated member UE selection information.

15. The communication device of claim 10, wherein the AF is configured to subscribe to a member UE selection assistance by sending a subscription request including a list of target UEs, one or more UE member filtering criteria, and/or one or more time windows; wherein the AF is configured to update the one or more UE member filtering criteria;
wherein the AF is configured to provide a subscription correlation identifier (ID).

16. The communication device of claim 15, wherein the subscriber is further configured to subscribe to the member UE selection information by sending a first subscription request.

17. The communication device of claim 16, wherein the NEF is configured to verify an authorization of an AF request, identify information which needs to be collected for each UE in a list of target UEs, and execute a service operation based on a member UE filtering criteria provided by the AF; and/or
wherein the NEF is configured to correlate a second subscription request to an existing subscription according to a subscription correlation ID.

18. The communication device of claim 15, wherein the NEF is configured to interact with NFs to collect information for each UE in the list of target UEs.

19. The communication device of claim 18, wherein based on a collected information from the NFs, the NEF is configured to consolidate all the information collected from the NFs to derive one or more lists of candidate UEs which fulfil the member UE filtering criteria in the AF request.

20. The communication device of claim 19, wherein the NEF is configured to send a notification request to the AF and/or to the subscriber if the subscriber has previously subscribed to the member UE selection information, by including the one or more lists of candidate UEs and/or additional information.
